(19) United States
(12) Patent Application Publication
(10) Pub. No.: US 2013/0269499 A1
(43) Pub. Date: Oct. 17, 2013

(54) SEPARATION TOOL, IN PARTICULAR SAW BLADE, FOR A MACHINE TOOL

(71) Applicant: ROBERT BOSCH GMBH, Stuttgart (DE)

(72) Inventor: Milan Bozic, Solothurn (CH)

(73) Assignee: Robert Bosch GmbH, Stuttgart (DE)

(21) Appl. No.: 13/863,436

(22) Filed: Apr. 16, 2013

(30) Foreign Application Priority Data
Apr. 17, 2012 (DE) 10 2012 206 250.5

(51) Int. Cl. B23D 61/12; B23D 61/00

(52) U.S. Cl. CPC B23D 61/123; B23D 61/128; B23D 61/006
USPC 83/697; 30/355; 83/651

(57) ABSTRACT

A separation tool, in particular saw blade, for a machine tool has a blade body with a wave structure with a changing wave form.

This application claims priority under 35 U.S.C. §119 to patent application no. DE 10 2012 206 250.5, filed on Apr. 17, 2012 in Germany, the disclosure of which is incorporated herein by reference in its entirety.

The disclosure relates to a separation tool, in particular saw blade, for a machine tool according to the description below.

### BACKGROUND

In DE 103 00 392 A1, a saw blade for a hand-held reciprocating sawing machine is described, which has a rectilinear cutting edge with cutting teeth on a blade body. The blade body is of wavy form, which is intended to improve the dissipation of heat during the tool machining and to increase the service life. The wavy section extends approximately between the shank via which the saw blade is fixed and the saw blade tip. The wave form is constant, and the waves can extend at right angles or at an angle of 45° to the cutting edge.

### SUMMARY

The disclosure is based on the object, by using simple measures, of forming a saw blade for a machine tool such that precise workpiece machining is possible over a long operating time period.

According to the disclosure, this object is achieved with the features described below. The description below also indicates expedient developments.

The disclosure relates to a saw blade for a machine tool, in particular a hand-held machine tool. The saw blade is formed, for example, as a jigsaw or saber saw blade which executes an oscillating, translational reciprocating movement. Also considered is an embodiment as a rotationally oscillating saw blade, for example as a plunge-cut saw blade or as a circular segment blade. Furthermore, embodiments as circular saw blades or hole saws are also possible.

The saw blade is provided with a blade body or supporting blade, which is adjoined by a cutting edge, which is preferably provided with cutting teeth. The blade body is a carrier of the cutting edge, in principle both one-piece embodiments of cutting edge and blade body and two-part embodiments being possible, in which the cutting edge is formed as a component configured separately from the blade body but joined to the blade body. In the case of a jigsaw or saber saw, the cutting edge can be formed rectilinearly or slightly curved.

In particular in conjunction with rotationally oscillating saw blades, circular saw blades or hole saws but also in conjunction with linear saw blades such as jigsaw or saber saw blades, the disclosure is not restricted by the provision of cutting teeth on the cutting edge. Instead, the disclosure can likewise be used advantageously on saw blades, the cutting edge of which and/or at least one flank adjoining the cutting edge is equipped with cutting and/or abrasive elements or, in addition to the cutting teeth on the cutting edge and/or at least one flank adjoining the cutting edge, is provided with cutting and/or abrasive elements. A cutting and/or abrasive element is understood here in particular to be a body having at least one cutting and/or grinding edge. The cutting and/or abrasive elements can for this purpose either have well-defined forms (e.g. ceramic micro cutting plates or elements) and also substantially undefined forms (e.g. ground grinding granules). Furthermore, the cutting and/or abrasive elements can consist at least partly, for example, of ceramic, hard metallic and/or hard mineral materials, preferably corundum or corundum-containing ceramics, silicon carbide, other carbides, and/or diamond. The cutting and/or abrasive elements are applied either in ordered form or else in unordered form to the cutting edge and/or to at least one flank adjoining the cutting edge. The cutting and/or abrasive elements are preferably adhesively bonded on, brazed on and/or welded on. Saw blades of this type according to the disclosure are designated generally as separation tools. If mention is made of saw blades below, this general definition is preferably always to be understood; in particular the consideration of cutting edge always includes an embodiment having cutting teeth and/or cutting and/or abrasive elements.

The blade body is of wavy form, at least in some sections. In order to reduce vibrations in the blade body and in the cutting edge during the workpiece machining and to reduce plastic deformations in the saw blade, which can arise as a result of bending or torsional moments, the waves in the blade body are non-constantly formed. With regard to the reduction in vibration, in this way detuning in the blade body is achieved, and with regard to the reduction in undesired deformations, an increase in the rigidity and strength is achieved. The non-constant waves can differ from one another with regard to the wave form, in particular in such a way that the wavelengths of the waves differ from one another. However, it is also possible, in addition or alternatively, to provide different wave heights of the various waves, the wave height extending orthogonally with respect to the plane of the blade body, whereas the wavelength lies in the plane of the blade body. Furthermore, the wave geometry of different waves, that is to say the geometric shape of the waves, can also be differently pronounced. Both in the event of a change in the wavelength and in the wave height or the wave geometry, the advantages of reduced vibrations and reduced deformation can be achieved. A set of waves is introduced into the blade body, comprising a plurality of individual mutually adjacent waves, at least two waves differing from one another with regard to the wavelength and/or wave height or possibly also in the wave geometry.

In principle, various possibilities for changing individual waves are suitable. The waves expediently all extend in the same direction within the plane of the blade body, and the wave height in all the individual waves is also advantageously formed variably in the orthogonal direction with respect to the plane of the blade body. A plurality of individual waves preferably differ from one another with regard to the wavelength and/or the wave height. In this case, both a continuous transition from long to short wavelength or wave height and also an abrupt transition are suitable, in which, for example, a plurality of sets of waves, each of which comprises a plurality of individual waves, are intrinsically formed with the same wavelength and/or wave height but the sets of waves differ from one another.

It may be advantageous, for example, for the waves to become continuously smaller or larger from one end to the other. However, an embodiment is also possible in which the waves are arranged in various subsections, in which wavelengths becoming smaller alternate with wavelengths becoming larger. For example, in the end regions the wavelength can be configured to be small and, in the intermediate, central region, the wavelength can be configured to be larger.

The waves have a longitudinal extent which either lies parallel to the cutting edge or forms an angle with the cutting edge, for example an angle of 45°. In this way, it is ensured that, as viewed over the length of the cutting edge, a change with regard to the wavelength and/or wave height of the waves is provided. The longitudinal extent of the cutting edge having the cutting teeth and the longitudinal extent of the waves thus run either parallel to each other or at an angle which lies in the angular range between 0° and 90°.

Also possible in principle, however, is a wave structure having a wave propagation at right angles to the cutting edge, the waves having a changing wavelength and/or wave height and/or wave geometry in the above-described manner.

The blade body advantageously has a constant wall thickness, at least in the area of the wavy section, which is achieved in particular by the blade body firstly being produced from a flat piece of metal of uniform thickness and the wave structure then being produced by embossing, the embossing direction lying at right angles to the plane of the blade body.

### BRIEF DESCRIPTION OF THE DRAWINGS

Further advantages and expedient embodiments can be gathered from description below, the figure description and the drawings, in which:

FIG. 1 shows in side view a jigsaw or saber saw blade having a blade body of which one side is formed as a cutting edge with cutting teeth, wherein waves of different wavelength are introduced into the blade body, the wavelength of which shortens from the fixing shank to the tip of the blade body,

FIG. 2 shows a further exemplary embodiment, in which the wavelength of the waves in the blade body lengthens from the fixing shank to the tip,

FIG. 3 shows a further exemplary embodiment, in which, respectively, shorter waves are introduced into the blade body adjacent to the fixing shank and the tip, and longer waves are introduced into the blade body in the intermediate region,

FIG. 4 shows a view from below in a schematic illustration of a saw blade,

FIG. 5 shows a plunge-cut saw blade, into the blade body of which a wave structure has likewise been introduced.

In the figures, identical components are provided with identical designations.

### DETAILED DESCRIPTION

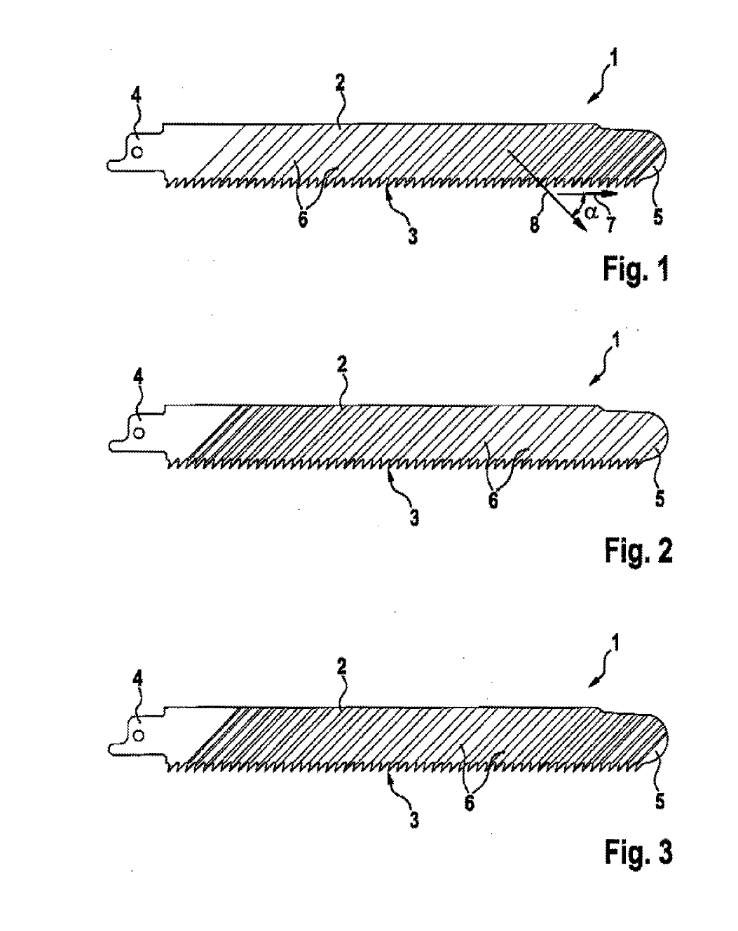

The exemplary embodiments according to FIGS. 1 to 4 relate to a saw blade for a machine tool having a translational, oscillating or to-and-fro working movement. The machine tool is in particular a hand-held machine tool, preferably a jigsaw or saber saw. The exemplary embodiment according to FIG. 5, on the other hand, relates to a rotationally oscillating saw blade in the form of a plunge-cut saw blade, which executes an oscillating rotational movement as working movement.

The saw blade according to FIG. 1 has a blade body 2 of which one side edge is formed as a cutting edge 3 with cutting teeth. The cutting edge 3 is rectilinear and extends in the longitudinal direction of the blade body 2. At one end, the saw blade 1 has a fixing shank 4, via which the saw blade is fixed in a holder in the machine tool. The sawing teeth on the cutting edge 3 extend between the fixing shank and the opposite, front tip 5 of the saw blade.

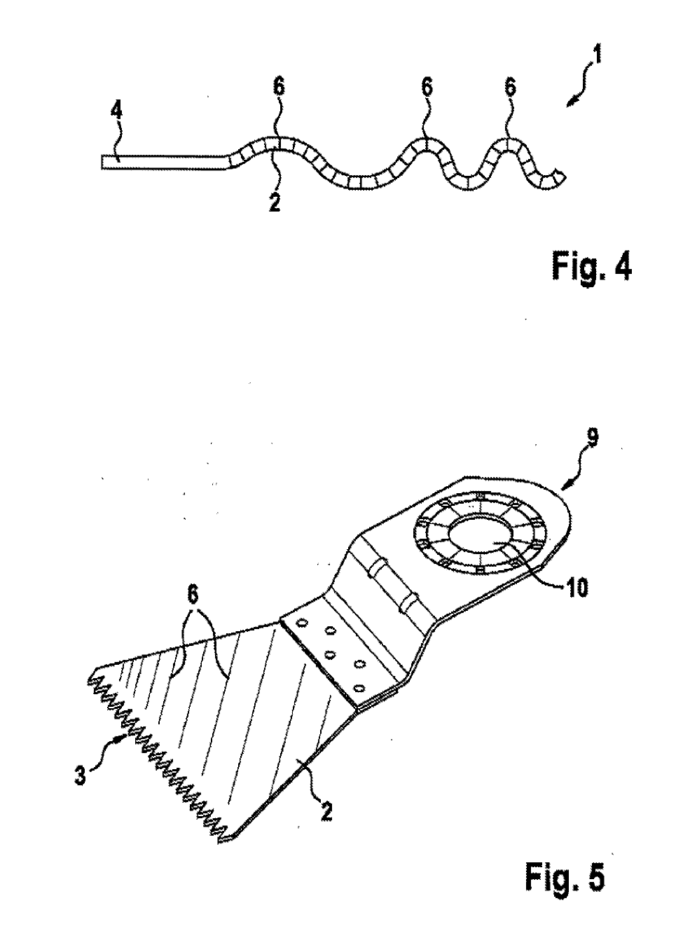

The blade body 2 of the saw blade has a wave structure with a multiplicity of waves 6 lying one behind another, which are introduced into the blade body 2 by embossings. The basic wave structure is illustrated schematically in FIG. 4. The embossings are introduced orthogonally with respect to the longitudinal plane of the blade body 2, so that the waves 6 exhibit peaks and troughs which, as compared with a mid-plane of the blade body, are arranged offset in the orthogonal direction. In order to produce the wave structure, the embossings are advantageously made on both side faces of the blade body 2.

As can further be gathered from FIG. 1, the waves 6 are inclined at an angle a with respect to the longitudinal axis 7 of the saw blade. The longitudinal extent of the waves 6 is identified by the arrow 8, which assumes the angle a with the longitudinal axis 7 and which, in the exemplary embodiment, is around 45°.

With reference to the longitudinal axis 7, the waves 6 exhibit a changing wavelength. Starting from the fixing shank 4, the wavelength decreases continuously toward the tip 5, so that, as can also be gathered from FIG. 4, the waves 6 have the greatest wavelength adjacent to the fixing shank 4 and the wavelength becomes smaller and smaller with increasing distance from the fixing shank 4. The wave height, which is measured orthogonally with respect to the mid-plane of the blade body, expediently remains the same in this case. However, embodiments are also possible in which the wave height also changes, in particular such that, as the wavelength becomes smaller, the height is also reduced.

The exemplary embodiment according to FIG. 2 corresponds substantially to that according to FIG. 1 but with the difference that the wavelength of the waves 6 which are introduced into the blade body 2 of the saw blade 1 by embossings decreases in the direction of the tip 5. Thus, the shortest waves 6 are found adjacent to the fixing shank 4 and the waves with the greatest wavelength adjacent to the tip 5.

In the exemplary embodiment according to FIG. 3, with reference to the longitudinal extent of the saw blade 1, the waves 6 are subdivided into subsections of different wavelength. Subsections with a shorter wavelength are respectively located adjacent to the fixing shank 4, on the one hand, and to the tip 5, on the other hand, whereas the central subsection located in between has waves 6 with a greater wavelength. Within a subsection, the waves have a constant wavelength.

The exemplary embodiment according to FIG. 5 shows a saw blade 1 which is configured as a plunge-cut saw blade and is used for a machine tool with a rotationally oscillating drive. The saw blade 1 has a mounting part 9 with a fixing cutout 10 introduced therein, which is used to hold a tool shaft of the machine tool. Latching openings in the mounting part 9 are grouped concentrically around the fixing cutout 10. The mounting part 9 is connected via a connecting section to the blade body 2, which is formed trapezoidally and widens trapezoidally on the side facing away from the mounting part 9. The cutting edge 3 is located on the side facing away from the mounting part 9 on the blade body 2 and is configured rectilinearly, if appropriate slightly curved.

As in the first exemplary embodiments, waves 6 are introduced into the blade body 2 by embossings, wherein the wave heights and depths are located offset orthogonally with respect to the mid-plane of the blade body 2. The longitudinal extent of the waves 6 likewise lies at an angle with respect to the cutting edge 3, for example a 45° angle. The wavelength of the waves 6 changes continuously.

What is claimed is:

1. A separation tool for a machine tool, comprising:
a blade body with at least one wavy section, the at least one wavy section having a wave form with at least one of a changing wavelength lying in a plane of the blade body, a changing wave height lying orthogonally with respect to the plane of the blade body, and a changing wave geometry; and
a cutting edge on the blade body.

2. The separation tool according to claim 1, wherein the wavelength and/or the wave height changes in a direction parallel to the cutting edge.

3. The separation tool according to claim 1, wherein a longitudinal extent of waves in the at least one wavy section lies at an angle to the cutting edge.

4. The separation tool according to claim 3, wherein the angle is 45°.

5. The separation tool according to claim 1, wherein waves of the at least one wavy section have a wavelength that becomes continuously smaller.

6. The separation tool according to claim 1, wherein waves of the at least one wavy section have first subsections with a wavelength that becomes smaller and second subsections with a wavelength that becomes greater.

7. The separation tool according to claim 1, wherein the blade body has a constant wall thickness in the at least one wavy section.

8. The separation tool according to claim 1, wherein waves in the at least one wavy section are produced by embossings.

9. The separation tool according to claim 1, wherein the separation tool is a rotationally oscillating saw blade.

10. The separation tool according to claim 1, wherein the separation tool is one of a jigsaw and a saber saw blade.

11. A machine tool, comprising:
a separation tool having:
a blade body with at least one wavy section, the at least one wavy section having a wave form with at least one of a changing wavelength lying in a plane of the blade body, a changing wave height lying orthogonally with respect to the plane of the blade body, and a changing wave geometry; and
a cutting edge on the blade body.

12. The separation tool according to claim 1, wherein the separation tool is a saw blade.
